(19) United States
(12) Patent Application Publication
(10) Pub. No.: US 2002/0135970 A1
(43) Pub. Date: Sep. 26, 2002

(54) Voltage-dependent thin-film capacitor

(76) Inventors: Mareike Klee, Huckelhoven (DE); Rainer Kiewitt, Roetgen (DE); Hans-Peter Lobl, Monschau-Imgenbroich (DE); Paul Van Oppen, Roermond (NL); Rob Derksen, Roermond (NL)

Correspondence Address: Algy Tamoshunas, Corporate Patent Counsel U S Philips Corporation, 580 White Plains Road, Tarrytown, NY, 10591, US

(21) Appl. No.: 09/541,765

(22) Filed: Apr. 3, 2000

(30) Foreign Application Priority Data
Apr. 3, 1999 (DE) 19915247.0

(51) Int. Cl. H01G 4/35

(52) U.S. Cl. 361/302

(57) ABSTRACT

The invention relates to a passive ceramic component with a carrier substrate (1), a first and a second electrode (2, 6), and a ferroelectric dielectric (5). The electrodes (2, 6) and the dielectric (5) preferably comprise a multilayer structure with at least a first and a second layer. The capacitance value C of the capacitor can be varied through the application of a voltage to the electrodes (2, 6), owing to the field dependence of the dielectric constant ≮ᵣ of the dielectric (5).

Such components may be used in filter devices or in delay lines or as replacements for variable-capacitance diodes in the manufacture of voltage-controlled oscillators.

The invention relates to a ceramic passive component which comprises a carrier substrate, at least a first electrode disposed thereon, at least a dielectric disposed thereon, and at least a second electrode disposed thereon. The invention also relates to components in which at least one ceramic passive component with the above construction is used.

Variable-capacitance diodes (also called varicaps) are diodes in which the voltage dependence of a pn junction is utilized in practice. Each pn junction forms a capacitor with the p- and the n-zone as the plates and the interposed depletion or blocking layer as the dielectric. The thickness of the depletion layer increases with the applied reverse voltage, so that the capacitance value of the pn junction decreases.

Variable-capacitance diodes are available in various embodiments. Typical operating voltages are 12 to 30 V accompanied by a capacitance which is variable by a factor 10 to 20. Lower voltages in a range from 3 to 5 V are usual in mobile telephone applications with a tuning range having a factor between 2 and 4. The capacitance values of the diodes usually vary between 20 and 40 pF in this case. These semiconductor components are used inter alia in the manufacture of voltage-controlled oscillators (VCOs).

The present trend is towards lower voltages and high frequencies (GHz) especially in the field of mobile telephony. The construction of variable-capacitance diodes for this application, however, becomes increasingly difficult, especially if the dimensions of the components have to be as small as possible. The semiconductor components also come close to the limits of their possibilities in view of their effective series resistance. In addition, the cost of manufacture of variable-capacitance diodes is very high.

The invention has for its object to provide a component which has a tunable capacitance as well as a low effective series resistance and which can be inexpensively manufactured.

This object is achieved by means of a ceramic passive component which comprises a carrier substrate, at least a first electrode disposed thereon, at least a dielectric disposed thereon, and at least a second electrode disposed thereon, wherein the dielectric comprises a ferroelectric ceramic material with a voltage-dependent relative dielectric constant

Given certain geometric dimensions (surface area A, electrode spacing d), the capacitance of a capacitor can be calculated from the equation:

C=(≮ᵣ·≮₀·A)/d.

A voltage dependence of the capacitance C is thus defined by the voltage dependence of the dielectric constant ≮ᵣ. Many dielectric materials exhibit a low dielectric constant ≮ᵣ and a low field dependence ≮ᵣ(E). An exception is formed by ferroelectric materials, in which ≮ᵣ can be changed through the application of an electric field E. The capacitance value C of a capacitor can thus be changed through the application of a voltage to the electrodes.

The advantages of these components are that on the one hand they are not polar, in contrast to variable-capacitance diodes, and on the other hand that they can be manufactured more cheaply than the semiconductor components.

It is to be highly preferred that the following is chosen as the ferroelectric ceramic material with a voltage-dependent dielectric constant ≮ᵣ:

Pb(ZrₓTi₁₋ₓ)O₃ (0≦x≦1) with and without excess lead, Ba₁₋ₓSrₓTiO₃ (0≦x≦1),

Pb_{1-1.5y}La_{y}(ZrₓTi₁₋ₓ)O₃ (0≦x≦1, 0≦y≦0.2), Pb(ZrₓTi₁₋ₓ)O₃ (0≦x≦1) doped with Nb, Pb_{1-αy}La_{y}TiO₃ (0≦y≦0.3, 1.3≦α≦1.5), (Pb,Ca)TiO₃, BaTiO₃ with and without dopants,

SrZrₓTi₁₋ₓO₃ (0≦x≦1) with and without Mn dopants, BaZr_{z}Ti₁₋ₓO₃ (0≦x≦1), SrTiO₃ doped with, for example, La, Nb, Fe or Mn,

[Pb(Mg_{⅓}Nb_{⅔})O₃]x—[PbTiO₃]₁₋ₓ (0≦x≦1),

(Pb,Ba,Sr)(Mg_{⅓}Nb_{⅔})ₓTi_{y}(Zn_{⅓}Nb_{⅔})_{1-x-y}O₃ (0≦x≦1, 0≦y≦1, x+y≦1),

PbNb_{⅘}x((Zr_{0.6}Sn_{0.4})_{1-y}Ti_{y}))₁₋ₓO₃ (0≦x≦0.9, 0≦y≦1), (Ba₁₋ₓCaₓ)TiO₃ (0≦x≦1),

(Ba₁₋ₓSrₓ)TiO₃ (0≦x≦1), (Ba₁₋ₓPbₓ)TiO₃ (0≦x≦1), (Ba₁₋ₓSrₓ)(Ti₁₋ₓZrₓ)O₃ (0≦x≦1, 0≦y≦1),

a) Pb(Mg_{½}W_{½})O₃

b) Pb(Fe_{½}Nb_{½})O₃

c) Pb(Fe_{½}W_{⅓})O₃

d) Pb(Ni_{⅓}Nb_{⅔})O₃

e) Pb(Zn_{⅓}Nb_{⅔})O₃

f) Pb(Sc_{½}Ta_{½})O₃

as well as combinations of the compounds a) to f) with PbTiO₃ and Pb(Mg_{⅓}Nb_{⅔})O₃ with and without excess lead.

All these ferroelectric ceramic materials have a high, voltage-dependent relative dielectric constant ≮ᵣ.

In another preferred embodiment, the first electrode and/or the second electrode comprise(s) at least a first and a second electrically conducting layer.

It is preferred that the first electrically conducting layer of the electrodes comprises Ti, Cr, NiₓCr_{y} (0≦x≦1, 0≦y≦1) or TiₓW_{y} (0≦x≦1, 0≦y≦1). These layers serve as adhesion layers.

It is furthermore preferred that the second electrically conducting layer of the electrodes comprises a metal or an alloy.

The electric current is mainly passed by the second, well conducting layer. A high conductivity of the materials used leads to a low effective series resistance (ESR) and a low parasitic inductance (ESL).

In a preferred embodiment it is provided that the carrier substrate comprises a ceramic material, a ceramic material with a glass planarization layer, a glass-ceramic material, a glass material, or silicon.

A carrier substrate made of a ceramic material, a ceramic material with a glass planarization layer, a glass-ceramic material, or a glass material can be inexpensively manufactured, so that the process cost for these components can be kept low. If the passive ceramic component is integrated into an IC, the carrier substrate will be of silicon, possibly provided with an SiO₂ passivating layer.

A further preferred embodiment is characterized in that the dielectric comprises multiple layers.

The use of multiple layers, for example double, triple or quadruple layers renders it possible to compensate for the unfavorable temperature behavior of some ferroelectric materials and to improve the temperature dependence of the capacitance value C.

It is also preferred that a protective layer of an inorganic material and/or an organic material is laid over the entire component.

The protective layer protects the subjacent layers against mechanical loads and against corrosion caused by moisture.

The invention also relates to components, in particular tunable filters or delay lines or voltage-controlled oscillators, which comprise as their capacitive component a ceramic passive component which comprises a carrier substrate, at least a first electrode disposed thereon, at least a dielectric disposed thereon, and at least a second electrode disposed thereon, which is characterized in that the dielectric comprises a ferroelectric ceramic material with a voltage-dependent relative dielectric constant ≮ᵣ.

The use of the component according to the invention, for example, in a tunable RCL filter, a passive delay line with electrically tunable delay time, or as a replacement for a variable-capacitance diode in voltage-controlled oscillators is advantageous because the component according to the invention can be mounted together with other components on a substrate, so that inexpensive circuits of small constructional dimensions can be manufactured.

The invention furthermore relates to the use of a ceramic passive component which comprises a carrier substrate, at least a first electrode disposed thereon, at least a dielectric with a voltage-dependent relative dielectric constant ≮ᵣ disposed thereon, and at least a second electrode disposed thereon, as a capacitive component.

The invention will be explained in more detail below with reference to five Figures and three embodiments, where

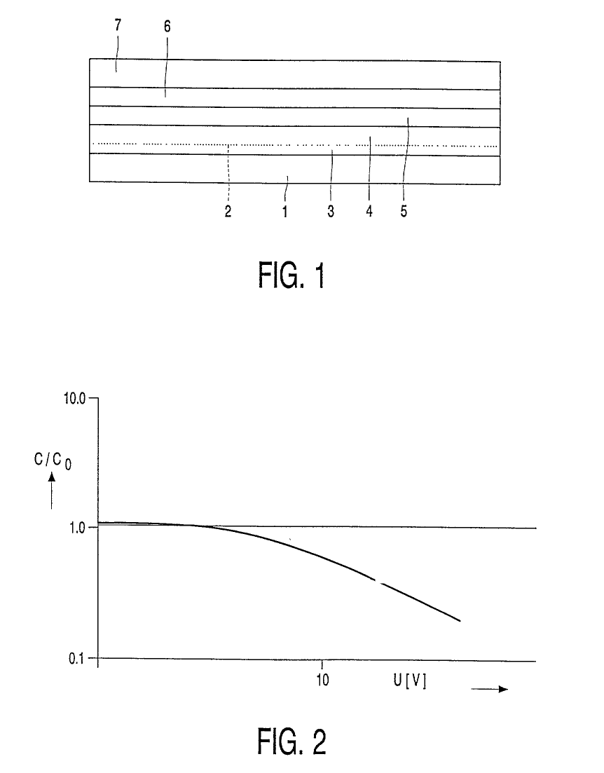

FIG. 1 in a diagrammatic, cross-sectional view shows the construction of a ceramic passive component,

FIG. 2 plots the capacitance as a function of the applied voltage in a ceramic passive component according to the invention,

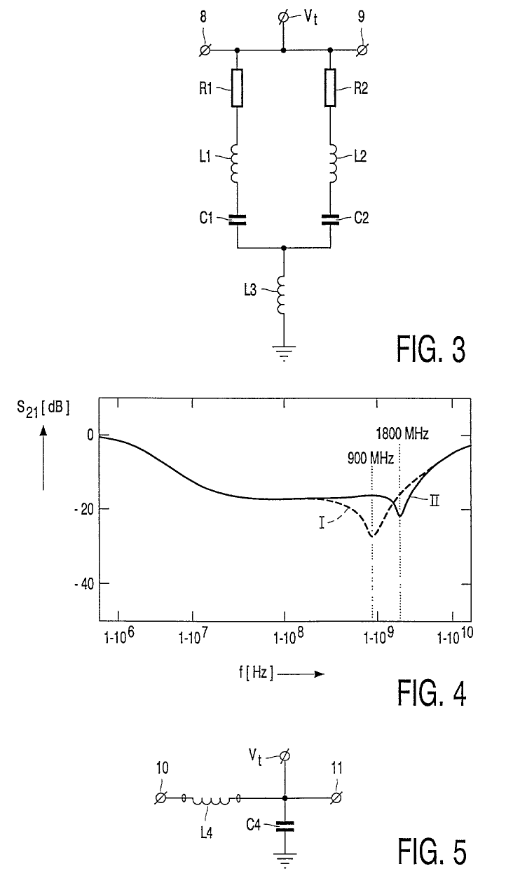

FIG. 3 is the circuit diagram of an RCL filter,

FIG. 4 shows the filter characteristic of an RCL filter which comprises a component according to the invention as its capacitive component, and

FIG. 5 is the circuit diagram of a passive LC delay member.

In FIG. 1, a ceramic passive component comprises a carrier substrate 1 which is made, for example, from a ceramic material, a ceramic material with a glass planarization layer, a glass-ceramic material, a glass material, or silicon with a passivating layer. On the carrier substrate there is a first electrode 2 which comprises a first electrically conducting layer 3 of, for example, Ti, Cr, NiₓCr_{y} (0≦x≦1, 0≦y≦1) or TiₓW_{y} (0≦x≦1, 0≦y≦1) and a second electrically conducting layer 4 comprising, for example, Pt, Ag, Ir, Ag₁₋ₓPtₓ (0≦x≦1), Ni, Cu, W, Ag₁₋ₓPdₓ (0≦x≦1), Al, Al doped with Cu, Al doped with Si or Al doped with Mg. A dielectric 5, for example made of Pb(ZrₓTi₁₋ₓ)O₃ (0≦x≦1) with and without excess lead,

Ba₁₋ₓSrₓTiO₃ (0≦x≦1),

Pb_{1-1.5y}La_{y}(ZrₓTi_{1-x)O}₃ (0≦x≦1, 0≦y≦0.2), Pb(ZrₓTi₁₋ₓ)O₃ (0≦x≦1) doped with Nb₃Pb_{1-αy}La_{y}TiO₃ (0≦y≦0.3, 1.3≦α≦1.5), (Pb,Ca)TiO₃, BaTiO₃ with and without dopants,

SrZrₓTi₁₋ₓO₃ (0≦x≦1)with and without Mn dopants, BaZrₓTi₁₋ₓO₃ (0≦x≦1), SrTiO₃ doped with, for example, La, Nb, Fe or Mn,

[Pb(Mg_{⅓}Nb_{⅔})O₃]ₓ—[PbTiO₃]₁₋ₓ (0≦x≦1),

(Pb,Ba,Sr)(Mg_{⅓}Nb_{⅔})ₓTi_{y}(Zn_{⅓}Nb_{⅔})_{1-x-y}O₃ (0≦x≦1, 0y≦1, x+y≦1),

PbNb_{⅘x}((Zr_{0.6}Sn_{0.4})_{1-y}Ti_{y}))₁₋ₓO₃ (0≦x≦0.9, 0≦y≦1), (Ba₁₋ₓCaₓ)TiO₃ (0≦x≦1),

(Ba₁₋ₓSrₓ)TiO₃ (0≦x≦1), (Ba₁₋ₓPbₓ)TiO₃ (0≦x≦1), (Ba₁₋ₓSrₓ)(Ti₁₋ₓZrₓ)O₃ (0≦x≦1, 0≦y≦1),

a) Pb(Mg_{½}W_{½})O₃

b) Pb(Fe_{½}Nb_{½})O₃

c) Pb(Fe_{⅔}W_{⅓})O₃

d) Pb(Ni_{⅓}Nb_{⅔})O₃

e) Pb(Zn_{⅓}Nb_{⅔})O₃

f) Pb(Sc_{½}Ta_{½})O₃

as well as combinations of the compounds a) to f) with PbTiO₃ and Pb(Mg_{⅓}Nb_{⅔})O₃ with and without excess lead is provided on the first electrode 2. On the dielectric 5 there is a second electrode 6 which is made of, for example, Pt, Ag, Ir, Ag₁₋ₓPtₓ (0≦x≦1), Ni, Cu, W, Ag1−xPdₓ (0≦x≦1), Al, Al doped with Cu, Al doped with Si or Al doped with Mg or YBa₂CuOₓ. A protective layer 7 of an organic and/or inorganic material is provided over the second electrode 6. The organic material used may be, for example, polybenzocyclobutene or polyimide, and the inorganic material may be, for example, Si₃N₄, SiO₂ or SiₓO_{y}N_{z} (0≦x≦1, 0≦y≦1, 0≦z ≦1).

Alternatively, the first electrode 2 may comprise only one electrically conducting layer of, for example, Pt, Ag, Ir, Ag₁₋ₓPtₓ (0≦x≦1), Ni, Cu, W, Ag₁₋ₓPdₓ (0≦x≦1), Al, Al doped with Cu, Al doped with Si, or Al doped with Mg, or YBa₂CuOx. In addition, the second electrode 6 may comprise at least a first and a second electrically conducting layer. The first electrically conducting layer may then comprise, for example, Ti, Cr, NiₓCr_{y} (0≦x≦1, 0≦y≦1) or TiₓW_{y} (0≦x≦1, 0≦y≦1). The material used for the second electrically conducting layer may be, for example, Pt, Ag, Ir, Ag₁₋ₓPtₓ (0≦x≦1), Ni, Cu, W, Ag₁₋ₓPdₓ (0≦x≦1), Al, Al doped with Cu, Al doped with Si or Al doped with Mg.

Yet further, for example third, fourth, and fifth electrically conducting layers may be provided on the respective second electrically conducting layers of the electrodes 2 and 6 as long as suitable combinations of the individual materials are formed. Materials which are suitable for forming a third electrically conducting layer are, for example, Ti, Ir, Ag, Cr, Al, IrOₓ (0≦x≦2), Ru, RuₓPt₁₋ₓ (0≦x≦1), PtₓAl₁₋ₓ (0≦x≦1), RhOₓ (0≦x≦2), PtₓRh₁₋ₓ (0≦x≦1), or ITO. A fourth electrically conducting layer may comprise, for example, IrOₓ (0≦x≦2), RuOₓ (0≦x≦2), RuₓPt₁₋ₓ(0≦x≦1), PtₓAl₁₋ₓ (0≦x≦1), RhOₓ (0≦x≦2), PtₓRh₁₋ₓ (0≦x≦1), or ITO. A fifth electrically conducting layer may be formed from, for example, RuOₓ (0≦x≦2) or RuₓPt₁₋ₓ (0≦x≦1).

At least a first and a second current supply contact may be provided at eitheer side of the ceramic passive component. A current supply contact may be, for example, an electroplated SMD end contact of Cr/Cu, Ni/Sn or Cr/Cu, Cu/Ni/Sn or Cr/Ni, Pb/Sn or a bump end contact or a contact surface.

The dielectric 5 may also comprise multiple layers, for example double, triple, or quadruple layers.

Furthermore, an anti-reaction layer made of, for example, TiO₂, Al₂O₃, ZrTiO₄ or ZrO₂ may be deposited on the carrier substrate 1. If silicon was used for the carrier substrate 1, the carrier substrate 1 may be provided with an SiO₂ passivating layer.

FIG. 3 shows an RCL filter arrangement consisting of a capacitor C1 with a defined capacitance value, a tunable capacitor C2, two resistors R1 and R2, and three inductances L1 to L3. The RCL filter comprises a first series arrangement of a resistor R1, an inductance L1, and a capacitor C1 connected in parallel to a second series arrangement of a resistor R2, an inductance L2, and a capacitor C2. The inductance L3 is connected in series with this parallel circuit and has one of its terminals connected to ground potential. The parallel circuit is thus connectd at one side to the inductance L3, while both the potential Vₜ and the connection terminals 8 and 9 are applied to the other side.

FIG. 5 shows the circuit arrangement of a passive LC delay member consisting of an inductance L4 and a capacitor C4 which are connected to one another. The junction point between the inductance L4 and the capacitor C4 is connected to a tap 10 and has potential Vₜ. The other connection is at a tap 11. The other terminal of the capacitor C4 is at ground potential.

Embodiments of the invention will be explained in more detail below, showing examples of how the invention may be carried into practice.

First an anti-reaction layer of TiO₂ and then a first electrically conducting layer 3 of Ti (10 nm) were deposited on a carrier substrate 1 of Al₂O₃ with a glass palanarization layer. A second electrically conducting layer 4 of Pt (500 nm) was deposited by sputtering on this first electrically conducting layer 3, and the two layers were structured by photolithography. Subsequently, a dielectric 5 of PbZz_{0.53}Ti_{0.47}O₃ with 5% La dotation was deposited in a sol-gel process, tempered at approximately 600° C. in an oxygen atmosphere, and structured by photolithography. The thickness of the dielectric was 0.75 μm. In the next step, a 500 nm Pt layer was deposited and structured photolithographically into an electrode 6. A protective layer 7 of Si₃N₄ and polyimide was deposited over the entire component. In addition, Cr/Cu, Ni/Sn SMD end contacts were fastened on mutually opposed sides of the component so as to serve as current supply contacts.

FIG. 2 shows the gradient of the capacitance of the ceramic passive component as a function of the applied voltage.

To achieve the same tuning range for the capacitance at lower voltages than those shown in FIG. 2, ceramic passive components with a thickness of the dielectric 5 of d=0.25 μm were manufactured in the manner indicated above. At a surface capacitance of 28 nF/mm², a ceramic passive component with a capacitance of 50 pF on an active surface area of approximately 1800 μm² (42.5 μm*42.5 μm) was manufactured, as well as a ceramic passive component with a capacitance of 5 pF on an active surface area of approximately 180 μm² (13.4 μm*13.4 μm).

The ceramic passive components thus formed were used in mobile telephones instead of variable-capcitance diodes.

A ceramic passive component was manufactured by the method as explained with reference to Embodiment 1 with a capacitance which was tunable in a range from 17 pF to 56 pF.

This ceramic passive component was used for realizing a tunable RCL filter which is to show a strong damping either at 900 MHz or at 1800 MHz. A capacitor C1 with a defined capacitance value and a tunable capacitor C2 were for this purpose combined with two resistors R1 and R2 and three inductances L1 to L3 into an RCL combination in accordance with the circuit arrangement of FIG. 3. The following were the values:

R1=5 Ω, L1=0.26 nH,C1=2.8 nF, and

R2=0.5 Ω, L2=0.26 nH, C2=variable between 17 and 56 pF, and

L3=0.3 nH.

The application of a DC voltage of a few volts is capable of varying the capacitance value of the capacitor C2 between 17 and 56 pF, whereby the region having a strong absorption in the filter characteristic can be shifted back and forth between 900 and 1800 MHz, as is shown in FIG. 4. Curve I in this FIG. corresponds to a capacitance value of the capacitor C2 of 56 pF and curve II to a capacitance value of 17 pF.

A ceramic passive component was manufactured by the method as explained with reference to Embodiment 1 with a capacitance which was tunable in a range from 1.4 nF to 2.8 nF through the application of a DC voltage of a few volts.

The ceramic passive component was used for realizing a passive LC delay member with an electrically changeable delay time t_{d}. The tunable capacitor C4 was for this purpose combined with an inductance L4 of 5.7 nH, as shown in FIG. 5.

The delay time t_{d}, which is given by: t_{d}=\sqrt{L*C}, can be shortened from 4 ns at a capacitance value of 2.8 nF to 2.8 ns in that the capacitance is changed to 1.4 nF.

1. A ceramic passive component which comprises a carrier substrate (1),
at least a first electrode (2) disposed thereon,
at least a dielectric (5) disposed thereon, and
at least a second electrode (6) disposed thereon,
characterized in that the dielectric (5) comprises a ferroelectric ceramic material with a
voltage-dependent relative dielectric constant ≮ᵣ.

2. A ceramic passive component as claimed in claim 1, characterized in that the following is chosen as the ferroelectric ceramic material with a voltage-dependent dielectric constant ≮ᵣ:
Pb(ZrₓTi₁₋ₓ)O₃ (0≦x≦1) with and without excess lead, Ba₁₋ₓSrₓTiO₃ (0≦x≦1),
Pb_{1-1.5y}La_{y}(ZrₓTi₁₋ₓ)O₃ (0≦x≦1, 0≦y≦0.2), Pb(ZrₓTi₁₋ₓ)O₃ (0≦x≦1) doped with Nb, Pb_{1-αy} La_{y}TiO₃ (0≦y≦0.3, 1.3≦α≦1.5), (Pb,Ca)TiO₃, BaTiO₃ with and without dopants,
SrZrₓTi₁₋ₓO₃ (0≦x≦1) with and without Mn dopants, BaZrₓTi₁₋ₓO₃ (0≦x≦1), SrTiO₃ doped with, for example, La, Nb, Fe or Mn,
[Pb(Mg_{⅓}Nb_{⅔})O₃]x—[PbTiO₃]₁₋ₓ (0≦x≦1),
(Pb,Ba,Sr)(Mg_{⅓}Nb_{⅔})ₓTi_{y}(Zn_{⅓}Nb_{⅔})_{1-x-y}O₃ (0≦x≦1, 0≦y≦1, x+y≦1),
PbNb_{⅘x}((Zr_{0.6}Sn_{0.4})_{1-y}Ti_{y}))₁₋ₓO₃ (0≦x≦0.9, 0≦y≦1), (Ba₁₋ₓCaₓ)TiO₃ (0≦x≦1),
(Ba₁₋ₓSrₓ)TiO₃ (0≦x≦1), (Ba₁₋ₓPbₓ)TiO₃ (0≦x≦1), (Ba₁₋ₓSrₓ)(Ti₁₋ₓZrₓ)O₃ (0≦x≦1,0≦y≦1),
a) Pb(Mg_{½}W_{½})O₃
b) Pb(Fe_{½}Nb_{½})O₃
c) Pb(Fe_{⅔}W_{⅓})O₃
d) Pb(Ni_{⅓}Nb_{⅔})O₃
e) Pb(Zn_{⅓}Nb_{⅔})O₃
f) Pb(Sc_{½}Ta_{½})O₃
as well as combinations of the compounds a) to f) with PbTiO₃ and Pb(Mg_{⅓}Nb_{⅔})O₃ with and without excess lead.

3. A ceramic passive component as claimed in claim 1, characterized in that the first electrode (2) and/or the second electrode (6) comprise(s) at least a first and a second electrically conducting layer.

4. A ceramic passive component as claimed in claim 3, characterized in that the first electrically conducting layer of the electrodes (2, 6) comprises Ti, Cr, NiₓCr_{y} (0≦x≦1, 0≦y≦1) or TiₓW_{y} (0≦x≦1, 0≦y≦1).

5. A ceramic passive component as claimed in claim 3, characterized in that the second electrically conducting layer of the electrodes (2, 6) comprises a metal or an alloy.

6. A ceramic passive component as claimed in claim 1, characterized in that the carrier substrate (1) comprises a ceramic material, a ceramic material with a glass planarization layer, a glass-ceramic material, a glass material, or silicon.

7. A ceramic passive component as claimed in claim 1, characterized in that the dielectric (5) comprises multiple layers.

8. A ceramic passive component as claimed in claim 1, characterized in that a protective layer (7) of an inorganic material and/or an organic material is laid over the entire component.

9. A voltage-controlled oscillator with as its capacitive component a ceramic passive component which comprises a carrier substrate (1), at least a first electrode (2) disposed thereon, at least a dielectric (5) disposed thereon, and at least a second electrode (6) disposed thereon, characterized in that the dielectric (5) comprises a ferroelectric ceramic material with a voltage-dependent relative dielectric constant ≮ᵣ.

10. A filter with as its capacitive component a ceramic passive component which comprises a carrier substrate (1), at least a first electrode (2) disposed thereon, at least a dielectric (5) disposed thereon, and at least a second electrode (6) disposed thereon, characterized in that the dielectric (5) comprises a ferroelectric ceramic material with a voltage-dependent relative dielectric constant ≮ᵣ. pg,12

11. A delay line with as its capacitive component a ceramic passive component which comprises a carrier substrate (1), at least a first electrode (2) disposed thereon, at least a dielectric (5) disposed thereon, and at least a second electrode (6) disposed thereon, characterized in that the dielectric (5) comprises a ferroelectric ceramic material with a voltage-dependent relative dielectric constant ≮ᵣ.

12. The use of a ceramic passive component which comprises a carrier substrate (1), at least a first electrode (2) disposed thereon, at least a dielectric (5) with a voltage-dependent relative dielectric constant ≮ᵣ disposed thereon, and at least a second electrode (6) disposed thereon as a capacitive component.
